(19) United States
(12) Patent Application Publication
(10) Pub. No.: US 2026/0221866 A1
(43) Pub. Date: Jul. 30, 2026

(54) BIDIRECTIONAL ISOLATED CONVERTER

(71) Applicant: SOLUTION X CO., LTD., Seoul (KR)

(72) Inventor: Gibum YU, Incheon (KR)

(73) Assignee: SOLUTION X CO., LTD., Seoul (KR)

(21) Appl. No.: 19/145,610

(22) PCT Filed: Jan. 5, 2024
(86) PCT No.: PCT/KR2024/000285

§ 371 Date: Aug. 1, 2025

(30) Foreign Application Priority Data
Jan. 5, 2023 (KR) 10-2023-0001623

(51) Int. Cl. H02M 1/088; H02M 1/00; H02M 3/00; H02M 3/335

(52) U.S. Cl. CPC H02M 1/088; H02M 1/0054; H02M 1/0077; H02M 1/0085; H02M 3/01; H02M 3/33573; H02M 3/33584

(57) ABSTRACT

The present invention relates to a bidirectional isolated converter that improves efficiency by increasing the power ratio transmitted from a first bridge. The converter comprises: a first bridge having at least one switch leg; a second bridge connected in parallel with the first bridge and also having a switch leg; a first transformer connected to the first bridge; a second transformer connected to the second bridge, wherein its secondary side is connected in series with the secondary side of the first transformer; a third bridge connected to the first transformer and second transformer secondary sides, with an output terminal for a load; and a control unit that switches the second and third bridges between boost and buck modes.

### CROSS-REFERENCE TO RELATED APPLICATIONS

This application is a 35 U.S.C. § 371 national phase of PCT International Application No. PCT/KR2024/000285, filed Jan. 5, 2024, which claims the benefit of priority under 35 U.S.C. § 119 to Korean Patent Application No. 10-2023-0001623, filed Jan. 5, 2023, the contents of which are incorporated herein by reference in its entirety.

### TECHNICAL FIELD

The present invention relates to a bidirectional isolated converter, and more particularly, to a bidirectional isolated converter having a wide output voltage range.

### BACKGROUND

A proportion of electric vehicles among all vehicles has recently increased due to a large-scale distribution of the electric vehicles. Compared to conventional gasoline or diesel-powered vehicles, the electric vehicle requires a longer battery charging time, which results in a growing need to increase the capacity of a rapid charger or an onboard charger to reduce the battery charging time of the electric vehicle. The rapid charger is required not only to increase the capacity but also to be capable of being operated in a wide system, such as a single-phase or a three-phase, or a battery voltage range.

FIG. 1 is a circuit diagram of a conventional onboard charger.

The conventional onboard charger shown in FIG. 1 is a capacitor-inductor-inductor-capacitor (CLLC) resonant converter based on frequency control, which may increase a switching frequency range due to a wide battery voltage range, thereby reducing efficiency, and increase the volume and cost of the charger itself due to many resonant elements (where the resonant elements are denoted by Lᵣ₁, Lᵣ₂, Lᵣ₃, Lᵣ₄, Cᵣ₁, Cᵣ₂, Cᵣ₃, Cᵣ₄, Lₘ₁, and Lₘ₂ shown in FIG. 1), reducing the efficiency.

Meanwhile, a conventional partial power converter is known in the art, and FIG. 2 is a schematic diagram of the partial power converter.

As shown in FIG. 2, the conventional partial power converter includes two modules: one is an unregulated converter module 10, and the other is a regulated converter module 20 that controls an output voltage through control. Each of the two modules may have an input and an output configured in a series/parallel or parallel/series structure, and transmit most of power to the unregulated converter module 10 and relatively low-level power to the regulated converter module 20. Here, the unregulated converter module 10 may have a fixed output voltage, whereas a variable range of the output voltage of the regulated converter module 20 may increase when a load (e.g., a battery) disposed at the output terminal of the partial power converter has a wide range. Therefore, a ratio of power transmitted from the unregulated converter module 10 to total power converted by the converter may decrease, thereby reducing efficiency of the partial power converter itself. For example, when a voltage range of a battery 30 shown in FIG. 2 ranges from 450 V to 850 V and the unregulated converter module 10 has a fixed voltage of 450 V, the output voltage of the regulated converter module 20 may range from zero to 400 V. When the output voltage of the regulated converter module 20 is 400 V, the voltage output from the unregulated converter module 10 may be 450 V among the total voltage of 850 V, which is a ratio of about 53%, thereby reducing the efficiency of the partial power converter.

### RELATED ART DOCUMENT

### Patent Document

Korean Patent Laid-Open Publication 10-2018-0109230 (entitled, “System and method for controlling initial charge of asymmetric modular multilevel converter”, published on Oct. 8, 2018)

An object of the present invention is to provide a bidirectional isolated converter capable of increasing a ratio of power transmitted from a first bridge to total transmitted power by the bidirectional isolated converter of the present invention to a predetermined level or more, thereby increasing efficiency.

In one general aspect, a bidirectional isolated converter includes: a first bridge receiving a direct current through an input terminal and including at least one switch leg including two switches operated complementarily; a second bridge receiving the direct current through an input terminal, including at least one switch leg including two switches operated complementarily, and connected in parallel with the first bridge; a first transformer including a first primary side and a first secondary side connected to the first bridge; a second transformer including a second primary side and a second secondary side connected to the second bridge, the second secondary side being connected in series with the first secondary side; a third bridge connected to the first secondary side and the second secondary side, including at least one switch leg including two switches operated complementarily, and having a load connected to an output terminal; and a control unit controlling the switches included in the second bridge and the third bridge to control the switches to be in either a boost mode or a buck mode.

The control unit may control the switches included in the switch leg included in each of the first to third bridges to have the same duty ratio, and adjust an output voltage of the third bridge by changing a phase difference between the switches included in the third bridge based on the switches included in the first bridge.

The switches included in the first bridge may have a fixed duty ratio.

The switches included in the first bridge may have the fixed duty ratio of 50%.

The first bridge may include a first switch leg and a second switch leg, which are connected in parallel with each other, the second bridge may include a third switch leg and a fourth switch leg, which are connected in parallel with each other, the third bridge may include a fifth switch leg and a sixth switch leg, which are connected in parallel with each other, and an n-th switch leg may include a (2n−1)-th switch and a (2n)-th switch, which are connected in series with each other and operated complementarily (where, n is a natural number greater than or equal to 1 and less than or equal to 6).

The first switch and the fourth switch may be turned on simultaneously, and in the boost mode, the control unit may control the eighth switch to be turned on simultaneously with the first switch, control the sixth switch to be turned on while having a predetermined phase difference from the eighth switch, and control the ninth switch and the twelfth switch to be turned on simultaneously while having a predetermined phase difference from the first switch.

The first switch and the fourth switch may be turned on simultaneously, and in the buck mode, the control unit may control the sixth switch to be turned on simultaneously with the first switch, control the sixth switch to be turned on while having a predetermined phase difference from the eighth switch, and control the ninth switch and the twelfth switch to be turned on simultaneously while having a predetermined phase difference from the first switch.

The control unit may calculate the phase difference between the sixth switch and the eighth switch and the phase difference between the ninth switch and the first switch based on a battery voltage.

The converter may include: a first inductor having one end connected between the fifth switch and the sixth switch and the other end connected to a low-voltage output terminal; and a second inductor having one end connected between the seventh switch and the eighth switch and the other end connected to the other end of the first inductor.

The first switch and the fourth switch may be turned on simultaneously, and in the boost mode, the control unit may control the fifth switch to be turned on while having a predetermined phase difference from the first switch, and the seventh switch to be turned on while having a phase difference of 180° from the fifth switch, control the eleventh switch to be turned on while having a predetermined phase difference from the second switch, and the tenth switch to be turned on while having a predetermined phase difference from the twelfth switch, and control the fifth switch and the seventh switch to be turned on while having a predetermined duty ratio.

The first switch and the fourth switch may be turned on simultaneously, and in the buck mode, the control unit may control the fifth switch to be turned on while having a predetermined phase difference from the first switch, and the seventh switch to be turned on while having a phase difference of 180° from the fifth switch, control the eleventh switch to be turned on while having a predetermined phase difference from the second switch, and the tenth switch to be turned on while having a predetermined phase difference from the twelfth switch, and control the fifth switch and the seventh switch to be turned on while having a predetermined duty ratio.

The control unit may control the predetermined duty ratio of the fifth switch and the seventh switch by using a difference between a current flowing through a low-voltage input terminal and a reference current and a difference between a voltage of the low-voltage input terminal and a reference voltage.

The load may be a battery, and the control unit may calculate the phase difference between the fifth switch and the first switch based on a battery voltage.

The converter may include: a resonant inductor disposed between one of the first transformer and the second transformer and the third bridge; and a resonant capacitor disposed between one of the first transformer and the second transformer and the third bridge.

The converter may further include a direct current (DC) link capacitor connected in parallel with the first bridge and the second bridge.

The converter may further include an output capacitor connected in parallel with the output terminal of the third bridge.

The control unit may calculate the phase difference between the switches included in the first bridge and the switches included in the third bridge based on a difference between a current flowing through the output terminal of the third bridge and a predetermined reference current.

A turns ratio of the first transformer may be 1:N1, and a turns ratio of the second transformer may be 1:N2, N1 being greater than N2.

In the bidirectional isolated converter according to the various embodiments of the present invention as described above, the switches included in the first bridge may be operated using the fixed duty ratio and the fixed phase, thereby reducing the volume of the passive components.

In addition, the bidirectional isolated converter according to the present invention may use fewer switches and resonant elements, thereby reducing the volume and cost and simplifying the design.

In addition, in the bidirectional isolated converter according to the present invention, the turns ratio of the first transformer may be greatly higher than that of the second transformer, thereby reducing the conduction loss and the switching loss occurring in the second bridge.

In addition, in the bidirectional isolated converter according to the present invention, the power output from the first bridge among the total power output from the third bridge may be increased to the predetermined reference value or more, more specifically, to three times more than the power output from the second bridge, thereby increasing the power transmission efficiency.

In addition, the bidirectional isolated converter according to another embodiment of the present invention may be operated as the interleaved buck converter by using the second bridge through the separately provided low-voltage output terminal, thereby responding to various low-voltage devices for a vehicle.

### BRIEF DESCRIPTION OF THE DRAWINGS

FIG. 1 is a circuit diagram of a conventional onboard charger.

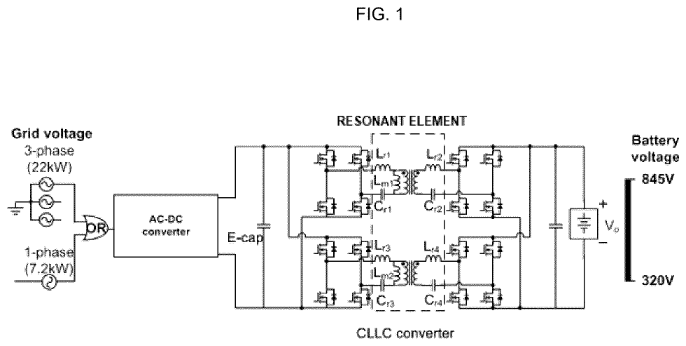

FIG. 2 is a schematic diagram of a partial power converter.

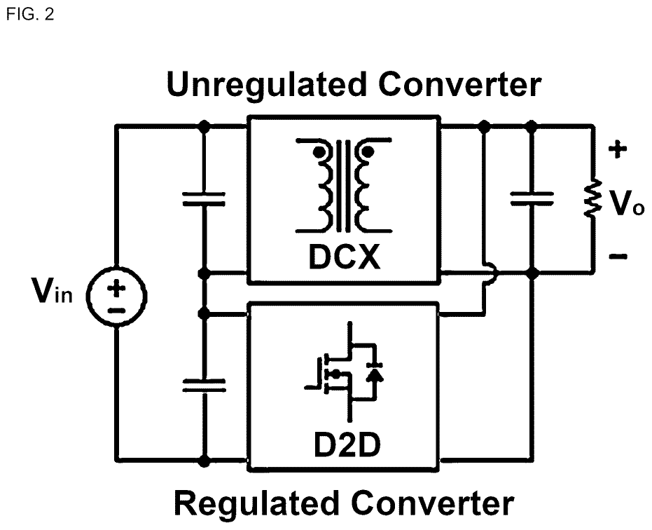

FIG. 3 is a circuit diagram of a bidirectional isolated converter according to an embodiment of the present invention.

FIG. 4 is a schematic diagram showing a principle of the bidirectional isolated converter according to an embodiment of the present invention.

FIG. 5 shows the switching graph and sensing value graph of each switch in a boost mode of the bidirectional isolated converter according to an embodiment of the present invention.

FIG. 6 shows the switching graph and sensing value graph of each switch in a buck mode of the bidirectional isolated converter according to an embodiment of the present invention.

FIG. 7 is a graph showing a battery voltage, an output voltage of a first transformer, an output voltage of a second transformer, and the sum of the output voltages of the first transformer and the second transformer during a process of converting the bidirectional isolated converter from the buck mode to the boost mode according to an embodiment of the present invention.

FIG. 8 is a graph showing values of the battery voltage, a battery current, a voltage V_{ab}, Φ_{boost}, and Φ_{buck} during the process of converting the bidirectional isolated converter from the buck mode to the boost mode according to an embodiment of the present invention.

FIG. 9 is a circuit diagram of a bidirectional isolated converter according to another embodiment of the present invention.

FIG. 10 is a schematic diagram of a generator included in the bidirectional isolated converter according to another embodiment of the present invention.

FIG. 11 shows the switching graph and sensing value graph of each switch in a boost mode of the bidirectional isolated converter according to another embodiment of the present invention.

FIG. 12 shows the switching graph and sensing value graph of each switch in a buck mode of the bidirectional isolated converter according to another embodiment of the present invention.

### DETAILED DESCRIPTION

The above-mentioned purposes, features, and advantages will become more apparent from the following embodiments provided in relation to the accompanying drawings. The following descriptions of specific structures and functions are provided only as examples to describe the embodiments based on a concept of the present invention. Therefore, the embodiments of the present invention may be implemented in various forms, and the present invention should not be construed as being limited to the embodiments described in this specification or application. The embodiments of the present invention may be variously modified and have several forms, and specific embodiments are thus shown in the accompanying drawings and described in detail in this specification or application. However, it should be understood that the present invention is not limited to the specific embodiments, and includes all modifications, equivalents, and substitutions included in the spirit and scope of the present invention. Terms such as “first” or “second” may be used to describe various components, and the components are not to be construed as being limited to the terms. The terms are used only to distinguish one component and another component from each other. For example, a “first” component may be named a “second” component and the “second” component may also be named the “first” component, without departing from the scope of the present invention. It should be understood that when one component is referred to as being connected to or coupled to another component, one component may be connected or coupled directly to another component or be connected or coupled to another component with yet another component interposed therebetween. On the other hand, it should be understood that when one component is referred to as being connected directly to or coupled directly to another component, one component may be connected or coupled to another component without yet another component interposed therebetween. Other expressions to describe a relationship between the components, i.e., “~between” and “directly between” or “adjacent to” and “directly adjacent to”, should be interpreted in the same manner as above. Terms used in this specification are used only to describe the specific embodiments rather than limit the present invention. A term of a singular number may include its plural number unless explicitly indicated otherwise in the context. It should be understood that terms “include”, “have”, or the like, used in this specification specify the presence of features, numerals, steps, operations, components, parts, or a combination thereof stated in this specification, but do not preclude the presence or addition of one or more other features, numerals, steps, operations, components, parts, or a combination thereof. Unless otherwise defined, all terms used herein, including technical or scientific terms, have the same meanings as those generally understood by those skilled in the art to which the present invention pertains. Terms generally used and defined in a dictionary should be interpreted as the same meanings as those within the context of the related art, and should not be interpreted as ideal or excessively formal meanings unless clearly indicated in this specification. Hereinafter, the present invention will be described in detail by describing an embodiment of the present invention with reference to the accompanying drawings. The same reference numerals in each drawing indicate the same member.

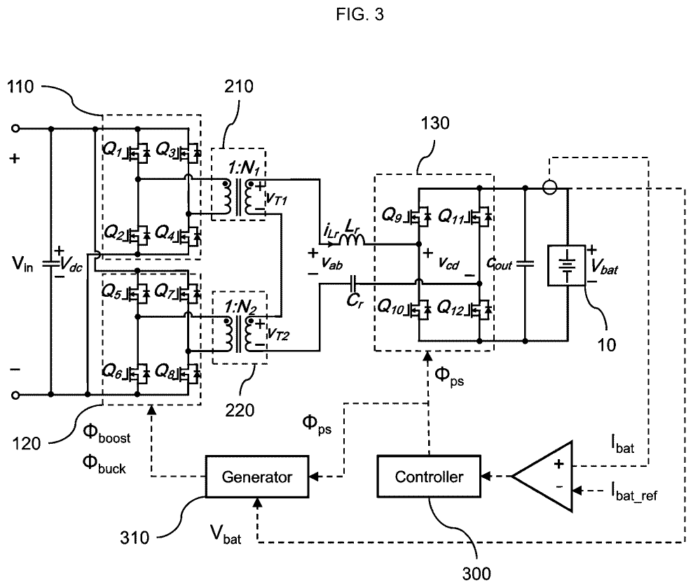

FIG. 3 is a circuit diagram of a bidirectional isolated converter according to an embodiment of the present invention.

As shown in FIG. 3, the bidirectional isolated converter according to an embodiment of the present invention may include a first bridge 110, a second bridge 120, a first transformer 210, a second transformer 220, and a third bridge 130.

The first bridge 110 may receive a direct current through an input terminal and include at least one switch leg including two switches operated complementarily.

As shown in FIG. 3, the first bridge 110 according to this embodiment may include two switch legs connected in parallel with each other. A sequence of the switch leg disposed on the left is described as being prior to a sequence of the switch leg disposed on the right. The first bridge 110 may include a first switch leg and a second switch leg, the first switch leg including a first switch Q1 and a second switch Q2, and the second switch leg including a third switch Q3 and a fourth switch Q4.

The switch included in the first bridge 110, i.e., the first switch Q1 to the fourth switch Q4, may be operated while having a fixed duty ratio and a fixed phase. That is, the first bridge 110 itself may not require active control, and accordingly, a control unit 300 described below may have fewer control targets, thereby simplifying its control and reducing the specification and size of a device required for the control unit 300, which may provide a more efficient and economical converter.

Similar to the first bridge 110, the second bridge 120 may receive the direct current through an input terminal, include at least one switch leg including two switches operated complementarily, and be connected in parallel with the first bridge 110. The second bridge 120 may include a third switch leg and a fourth switch leg. The third switch leg may include a fifth switch Q5 and a sixth switch Q6 connected in series with each other, and the fourth switch leg may include a seventh switch Q7 and an eighth switch Q8. The switch included in the second bridge 120, i.e., each of the fifth switch Q5 to the eighth switch Q8, may be controlled by the control unit 300 described below.

The first transformer 210 may include a first primary side and a first secondary side. According to a characteristic of the transformer, the first primary side and the first secondary side may be insulated from each other. The first primary side may have one end connected to a node between the first switch Q1 and the second switch Q2 and the other end connected to a node between the third switch Q3 and the fourth switch Q4. A turns ratio of the first transformer 210 may be expressed as 1:N1. The first transformer 210 may receive an output voltage, which is boosted or bucked by an operation of the switch included in the first bridge 110, from the first primary side and output the same to the first secondary side. The output voltage of the first transformer 210 is referred to as VT1.

The second transformer 220 may include a second primary side and a second secondary side. According to a characteristic of the transformer, the second primary side and the second secondary side may be insulated from each other. The second primary side may have one end connected to a node between the fifth switch Q5 and the sixth switch Q6 and the other end connected to a node between the seventh switch Q7 and the eighth switch Q8. A turns ratio of the second transformer 220 may be expressed as 1:N2. The second transformer 220 may receive an output voltage, which is boosted or bucked by an operation of the switch included in the second bridge 120, from the second primary side and output the same to the second secondary side. The output voltage of the second transformer 220 is referred to as VT2. The first secondary side and second secondary side of the first transformer 210 may be connected in series with each other.

Among the turns ratio N1 of the first transformer 210 and the turns ratio N2 of the second transformer 220, N1 may be greater than N2, and specifically, N1 may be 2.5 times or more than N2. For example, when a voltage range of a battery 10 ranges from V_{batmin} to V_{batmax}, a ratio of N1 and N2 may be defined as in the following equation.

$$N 1 : N 2 = \frac{( {V}_{batmax} + {V}_{batmin} )}{2} : ( {V}_{batmax} - {V}_{batmin} )$$

When the voltage range of the battery 10 ranges from 400 V to 800 V, V_{batmin} may be 400 V and V_{batmax} may be 800 V. Therefore, N1:N2 may be 600:200, and N1 may be 3 times that of N2.

The third bridge 130 may be connected to the first secondary side of the first transformer 210 and the second secondary side of the second transformer 220. The third bridge 130 may include at least one switch leg including two switches operated complementarily, and having a load connected to an output terminal. As shown in FIG. 3, the third bridge 130 according to this embodiment may include two switch legs, i.e., a fifth switch leg and a sixth switch leg. The fifth switch leg may include a ninth switch Q9 and a tenth switch Q10 connected in series with each other, and the sixth switch leg may include an eleventh switch Q11 and a twelfth switch Q12 connected in series with each other, the ninth switch Q9 to the twelfth switch Q12 being controlled by the control unit 300 described below. The load connected to the output terminal of the third bridge 130 may be the battery 10. The first secondary side of the first transformer 210 may be connected to a node between the ninth switch Q9 and the tenth switch Q10, and the second secondary side of the second transformer 220 may be connected to a node between the eleventh switch Q11 and the twelfth switch Q12.

The control unit 300 may control the switches included in the second bridge 120 and the third bridge 130 to control the bidirectional isolated converter to be in either a boost mode or a buck mode according to this embodiment. The control unit 300 may be implemented as a type of device that includes electronic components to transmit a control signal to each switch and receive various sensor values, and may be connected to each switch and sensor in a wired or wireless manner.

As shown in FIG. 3, the bidirectional isolated converter according to an embodiment of the present invention may further include a resonant inductor Lᵣ, a resonant capacitor Cᵣ, a direct current (DC) link capacitor, and an output capacitor Cₒᵤₜ.

The resonant inductor Lᵣ and the resonant capacitor Cᵣ may be disposed between the third bridge 130 and the secondary side of the transformer, and the resonant inductor Lᵣ and the resonant capacitor Cᵣ may be connected in series with the first secondary side of the first transformer 210 and the second secondary side of the second transformer 220. The resonant inductor may be disposed between the first secondary side of the first transformer 210 and the third bridge 130, or between the second secondary side of the second transformer 220 and the third bridge 130. The resonant capacitor may also be disposed between the first secondary side of the first transformer 210 and the third bridge 130, or between the second secondary side of the second transformer 220 and the third bridge 130. The reason is that all structures are circuit-wise identical as long as the resonant inductor and the resonant capacitor are disposed in the positions described above.

The DC link capacitor may be connected in parallel with the first bridge 110 and the second bridge 120, and the output capacitor Cₒᵤₜ may be connected in parallel with the third bridge 130, i.e., the output terminal of the third bridge 130.

The bidirectional isolated converter including the components described above according to the present invention may include fewer switches and resonant elements than those in previously proposed partial power converters, thereby reducing the volume and cost of the bidirectional isolated converter according to the present invention and simplifying its design.

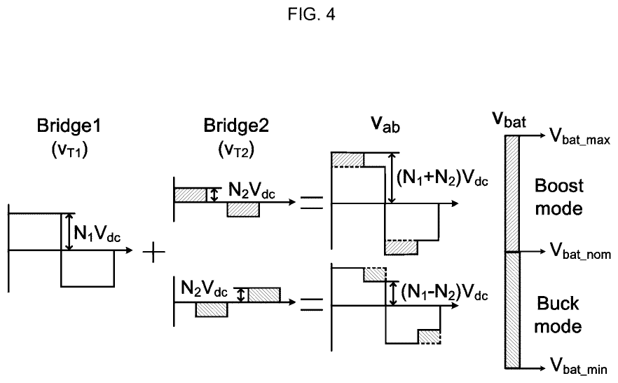

FIG. 4 is a schematic diagram showing a principle of the bidirectional isolated converter according to an embodiment of the present invention.

A voltage V_{ab} output from the secondary side of the present invention may be determined as the sum of V_{T1}, which is a voltage output from the first secondary side of the first transformer 210, and V_{T2}, which is a voltage output from the second primary side of the second transformer 220. As described above, the switch in the first bridge 110 may have the fixed duty ratio and phase. Accordingly, V_{T1}, which is the output voltage of the first transformer 210, may be constant as shown in FIG. 4. Conversely, V_{T2}, which is the output voltage of the second transformer 220, may have the same polarity as V_{T1} during at least some periods in the boost mode, and have the opposite polarity to V_{T1} during at least some periods in the buck mode. The above-described operation according to the present invention may result in a magnitude of V_{ab} being greater than V_{T1} in the boost mode and smaller than V_{T1} in the buck mode, where a magnitude deviation is smaller than that of the conventional partial power converter. The present invention may reduce the deviation in changing a magnitude to thus increase a ratio of power output from the first bridge 110 to the first transformer 210 to total transmitted power by the bidirectional isolated converter according to this embodiment to a predetermined level or more, for example, 75% or more, thereby further improving efficiency of the converter.

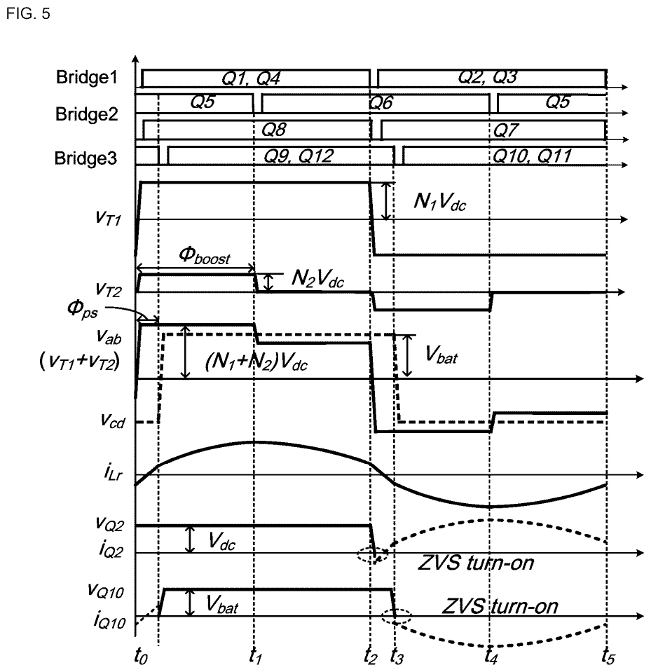

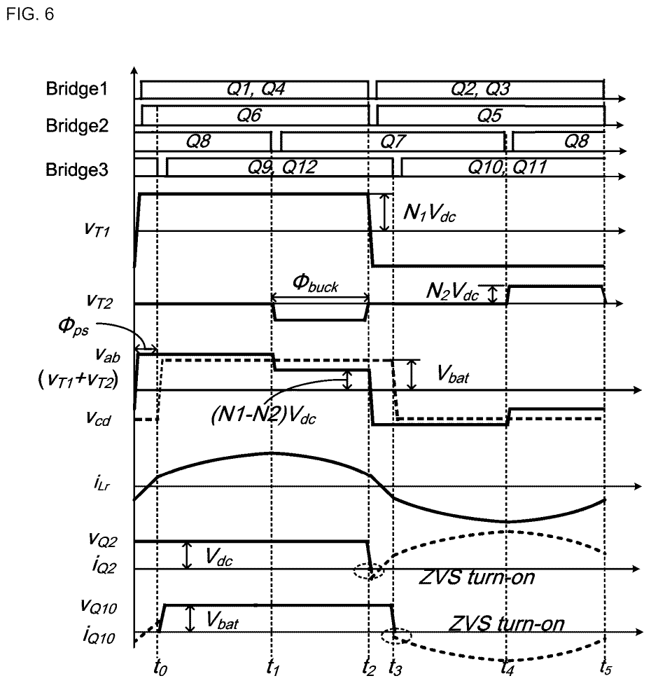

FIGS. 5 and 6 show the switching graph and sensing value graph of each switch in the boost mode or buck mode of the bidirectional isolated converter according to an embodiment of the present invention.

As shown in FIG. 5, the control unit 300 according to this embodiment may control the fifth switch Q5 to the twelfth switch Q12 to have a fixed duty ratio of 50% regardless of the operation mode. The first switch Q1 to the fourth switch Q4 may have the fixed duty ratio of 50% regardless of the control by the control unit 300.

The first switch Q1 to the fourth switch Q4 included in the first bridge 110 may be turned on together regardless of the operation mode. The second switch Q2 and the third switch Q3 may be operated complementarily to the first switch Q1 and the fourth switch Q4, respectively.

As shown in FIG. 5A, the control unit 300 according to this embodiment may control the eighth switch Q8, among the fifth switch Q5 to the eighth switch Q8 included in the second bridge 120, to be turned on together with the first switch Q1 and the fourth switch Q4 when operated in the boost mode. The seventh switch Q7 may be operated complementarily to the eighth switch Q8 and may thus be turned on together with the second switch Q2 and the third switch Q3. In addition, the control unit 300 may control the fifth switch Q5, among the fifth switch Q5 to the eighth switch Q8, to be turned on while having a predetermined phase difference from the first switch Q1. Here, the predetermined phase difference is referred to as Φ_{boost}.

In addition, when operated in the boost mode, the control unit 300 according to this embodiment may control the ninth switch Q9 and the twelfth switch Q12, among the ninth switch Q9 to the twelfth switch Q12 included in the third bridge 130, to be turned on together, and control the ninth switch Q9 to be turned on while having a predetermined phase difference from the first switch Q1. Here, the phase difference between the ninth switch Q9 and the first switch Q1 is referred to as Φₚₛ.

The phase difference Φₚₛ between the ninth switch Q9 and the first switch Q1 may serve to adjust the output voltage of the third bridge 130. More specifically, when the control unit 300 increases Φₚₛ to control the third bridge 130, a magnitude of a current i_{L}_{ᵣ} flowing through the resonant inductor Lᵣ during a period corresponding to the phase difference Φₚₛ between the first switch Q1 and the ninth switch Q9 may be increased, thereby increasing an amount of power transmitted to the third bridge 130. Conversely, when the control unit 300 decreases Φₚₛ to control the third bridge 130, the magnitude of the current i_{L}_{ᵣ} flowing through the resonant inductor Lᵣ during the period corresponding to the phase difference Φₚₛ between the first switch Q1 and the ninth switch Q9 may be reduced, thereby reducing the amount of power transmitted to the third bridge 130. Here, the reduction indicates a case where, when the bidirectional isolated converter according to this embodiment is operated in the boost mode, a boosting degree is increased or decreased depending on Φₚₛ, and does not indicate that the converter is operated in the boost mode or in the bucked mode depending on Φₚₛ.

As shown in FIG. 5B, the control unit 300 according to this embodiment may control the sixth switch Q6, among the fifth switch Q5 to the eighth switch Q8 included in the second bridge 120, to be turned on together with the first switch Q1 and the fourth switch Q4 when operated in the buck mode. The sixth switch Q6 may be operated complementarily to the fifth switch Q5, and the fifth switch Q5 may thus be turned on together with the second switch Q2 and the third switch Q3. In addition, the control unit 300 may control the eighth switch Q8, among the fifth switch Q5 to the eighth switch Q8, to be turned on while having a predetermined phase difference from the first switch Q1. Here, the predetermined phase difference is referred to as Φ_{buck}.

Even when operated in the buck mode, the control unit 300 according to this embodiment may control the ninth switch Q9 and the twelfth switch Q12, among the ninth switch Q9 to the twelfth switch Q12 included in the third bridge 130, to be turned on together, and control the ninth switch Q9 to be turned on while having a predetermined phase difference from the first switch Q1. Here, the phase difference between the ninth switch Q9 and the first switch Q1 is referred to as Φₚₛ. However, in the buck mode, V_{T2} output from the second bridge 120 and the second transformer 220 may have the opposite polarity to V_{T1}. Accordingly, when the control unit 300 increases Φₚₛ, the amount of power transmitted to the third bridge 130 may be reduced, and when Φₚₛ is decreased, the amount of power transmitted to the third bridge 130 may be increased. Here, the increase or the reduction indicates a case where, when the bidirectional isolated converter according to this embodiment is operated in the buck mode, a bucking degree is increased or decreased depending on Φₚₛ, and does not indicate that the converter is operated in the boost mode or in the buck mode depending on Φₚₛ.

The control unit 300 may receive a current I_{bat} flowing toward the load (e.g., the battery 10) of the bidirectional isolated converter according to this embodiment and a predetermined reference current I_{bat_ref}, and calculate Φₚₛ. To this end, the bidirectional isolated converter according to an embodiment of the present invention may further include a current sensor for sensing the current flowing toward the load.

Φ_{boost} and Φ_{buck} described above may serve to prevent a transient state from being abrupt during a process of converting the bidirectional isolated converter according to the present invention from the buck mode to the boost mode.

As shown in FIG. 3, the control unit 300 included in the bidirectional isolated converter according to an embodiment of the present invention may further include a generator 310. The generator 310 may serve to generate Φ_{boost} and Φ_{buck} as described above. The generator 310 may receive Φₚₛ and V_{bat}, which is the battery voltage, and operate and generate Φ_{boost} and Φ_{buck} depending on whether the operation mode is the boost mode or the buck mode. To this end, the bidirectional isolated converter according to an embodiment of the present invention may further include a voltage sensor for sensing the battery voltage.

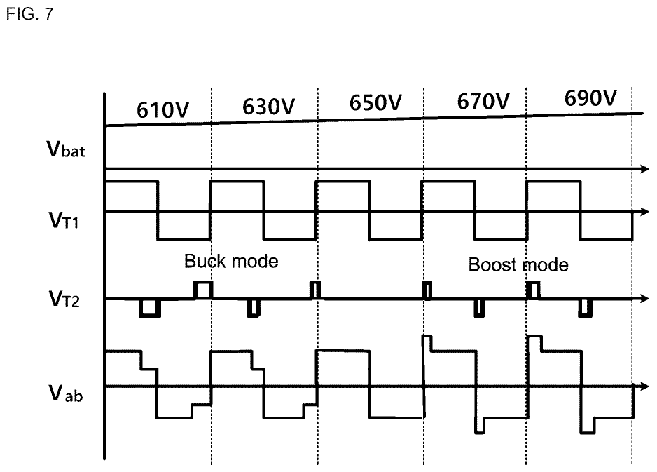

FIG. 7 is a graph showing a battery voltage, an output voltage of a first transformer, an output voltage of a second transformer, and a sum of the output voltages of the first transformer and the second transformer during the process of converting the bidirectional isolated converter from the buck mode to the boost mode according to an embodiment of the present invention.

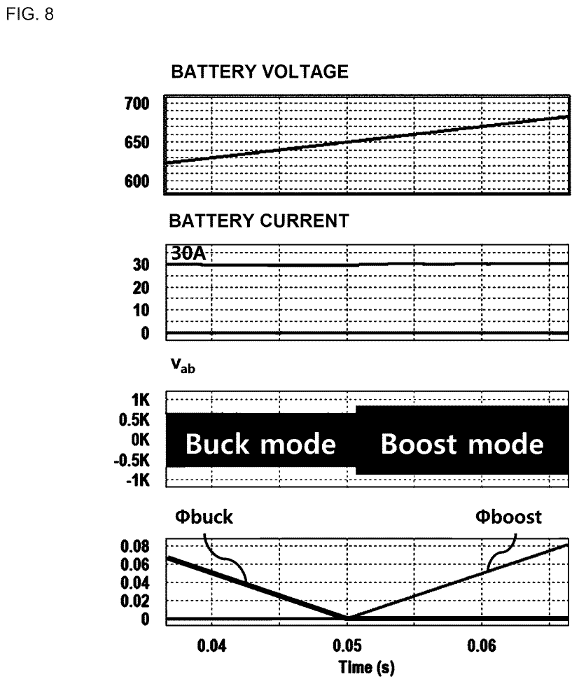

FIG. 8 is a graph showing values of the battery voltage, a battery current, a voltage Vab, Φ_{boost}, and Φ_{buck} during the process of converting the bidirectional isolated converter from the buck mode to the boost mode according to an embodiment of the present invention.

As shown in FIGS. 7 and 8, the battery current may be constant even if the bidirectional isolated converter according to this embodiment is switched from the buck mode to the boost mode, and the battery voltage is increased. That is, the transient state may not occur even if the mode according to this embodiment is switched, thus requiring no separate control for the transient state that may occur due to the mode switch. Φ_{buck} may be decreased as the battery voltage is increased while the bidirectional isolated converter according to this embodiment is operated in the buck mode, and Φ_{boost} may be increased as the battery voltage is increased while the bidirectional isolated converter according to this embodiment is operated in the boost mode.

Next, a bidirectional isolated converter according to another embodiment of the present invention is described. The bidirectional isolated converter according to another embodiment of the present invention aims to implement an interleaved buck converter by using the second bridge 120 according to an embodiment. Specifically, the bidirectional isolated converter according to this embodiment aims to further include a low-voltage output terminal for outputting a low voltage of 12 V, which is lower than a voltage output from a conventional input terminal, through a first inductor L1 and a second inductor L2, in addition to the conventional input terminal for inputting or outputting a conventional voltage of 48 V. In this way, by including the low-voltage output terminal, the bidirectional isolated converter according to another embodiment of the present invention may include the input/output terminal corresponding to the battery voltage, the input/output terminal corresponding to a voltage such as 48 V, and the input/output terminal corresponding to a low voltage such as 12 V, which is lower than the voltage of 48 V, thereby being enabled to respond to various low-voltage components for a vehicle.

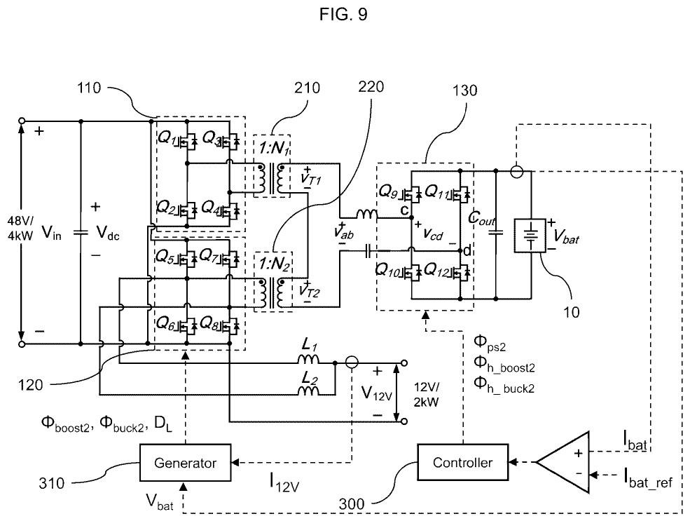

FIG. 9 is a circuit diagram of the bidirectional isolated converter according to another embodiment of the present invention.

As shown in FIG. 9, the bidirectional isolated converter according to another embodiment of the present invention may include the first inductor L1 and the second inductor L2 in addition to the first bridge 110, the second bridge 120, the first transformer 210, the second transformer 220, and the third bridge 130 according to an embodiment. Specifically, the bidirectional isolated converter according to another embodiment of the present invention may include the first inductor L1 having one end connected between the fifth switch Q5 and the sixth switch Q6 and the other end connected to the low-voltage output terminal, and the second inductor L2 having one end connected between the seventh switch Q7 and the eighth switch Q8 and the other end connected to the other end of the first inductor L1.

The first bridge 110, the second bridge 120, the first transformer 210, the second transformer 220, and the third bridge 130 included in the bidirectional isolated converter according to another embodiment of the present invention have the same configurations and characteristics as those of the first bridge 110, the second bridge 120, the first transformer 210, the second transformer 220, and the third bridge 130 according to an embodiment. Therefore, descriptions of the first bridge 110, the second bridge 120, the first transformer 210, the second transformer 220, and the third bridge 130 are omitted.

The control unit 300 may control the switches included in the second bridge 120 and the third bridge 130 to control the bidirectional isolated converter according to another embodiment in either the boost mode or the buck mode. The control unit 300 may be implemented as a type of device that includes the electronic components to transmit the control signal to each switch and receive the various sensor values, and may be connected to each switch and sensor in the wired or wireless manner.

However, the method in which the control unit 300 according to an embodiment described above controls each switch of the second and third bridges 120 and 130 is different from a method in which the control unit 300 according to another embodiment described below controls each switch of the second and third bridges 120 and 130.

The bidirectional isolated converter according to another embodiment of the present invention may further include the resonant inductor Lᵣ, the resonant capacitor Cᵣ, the DC link capacitor, and the output capacitor Cₒᵤₜ. The resonant inductor Lᵣ, the resonant capacitor Cᵣ, the DC link capacitor, and the output capacitor Cₒᵤₜ according to another embodiment have the same configurations and characteristics as those according to an embodiment. Therefore, descriptions of the resonant inductor Lᵣ, the resonant capacitor Cᵣ, the DC link capacitor, and the output capacitor Cₒᵤₜ according to another embodiment are omitted.

The bidirectional isolated converter according to another embodiment of the present invention that includes the components described above may include fewer switches and resonant elements than those in the previously proposed partial power converters, as described in an embodiment, thereby reducing the volume and cost of the bidirectional isolated converter according to the present invention and simplifying its design. Further, in addition to the effect achieved in an embodiment, the bidirectional isolated converter according to another embodiment may implement the interleaved buck converter by using the first inductor L1 and the second inductor L2, thereby being further provided with not only the terminal of 48 V but also the low-voltage terminal of 12V, and thus responding to a wider voltage range.

A principle of the bidirectional isolated converter according to another embodiment of the present invention is also the same as the principle of the bidirectional isolated converter according to an embodiment of the present invention shown in FIG. 4.

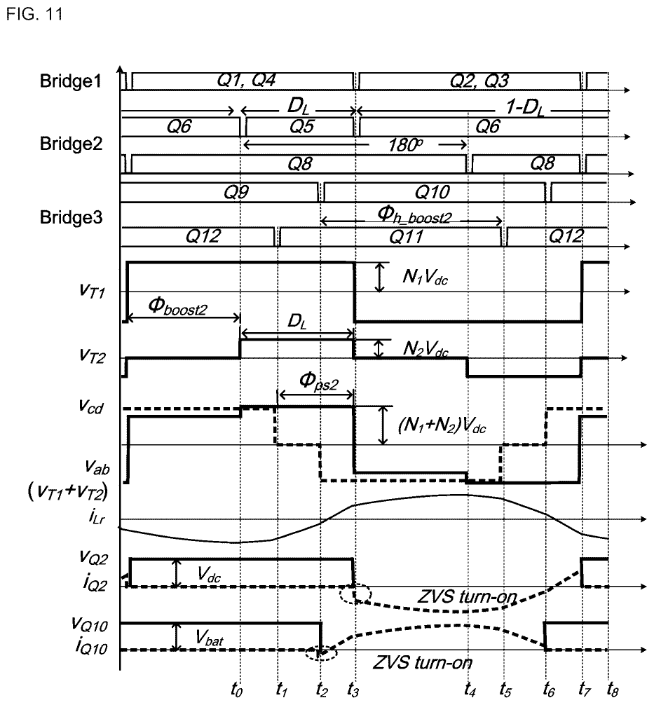

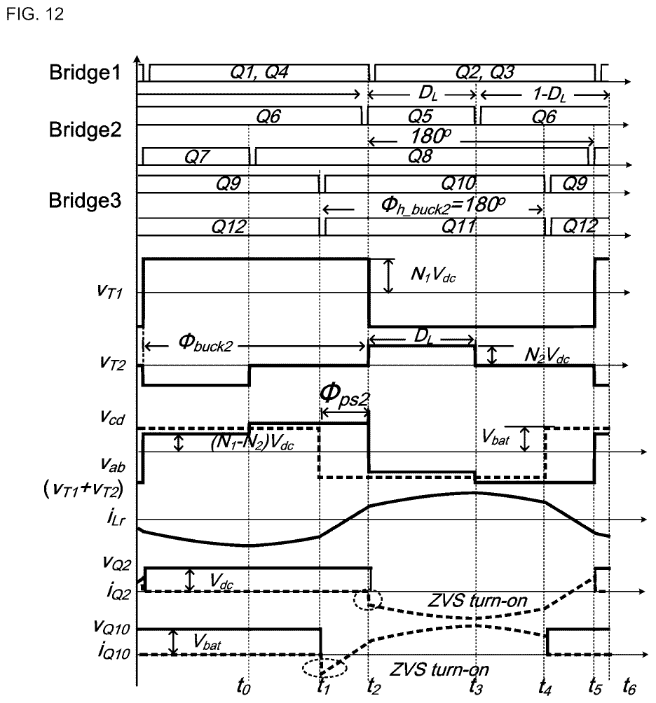

FIG. 11 shows the switching graph and sensing value graph of each switch in the boost mode of the bidirectional isolated converter according to another embodiment of the present invention, and FIG. 12 shows the switching graph and sensing value graph of each switch in the buck mode of the bidirectional isolated converter according to another embodiment of the present invention.

Referring to FIGS. 11 and 12, also in the bidirectional isolated converter according to another embodiment of the present invention, V_{T2}, which is the output voltage of the second transformer 220, may have the same polarity as V_{T1} during at least some periods in the boost mode, and have the opposite polarity to V_{T1} during at least some periods in the buck mode. Accordingly, the bidirectional isolated converter according to another embodiment of the present invention may also be operated based on the same principle as in an embodiment of the present invention. Therefore, the magnitude of V_{ab} may be greater than V_{T1} in the boost mode, and smaller than V_{T1} in the buck mode. However, the magnitude deviation may be smaller than that in the conventional partial power converter.

As shown in FIGS. 11 and 12, the control unit 300 according to another embodiment may control the fifth switch Q5 and the seventh switch Q7 included in the second bridge to be turned on while having a duty ratio of D_{L}, and control the sixth switch Q6 and the eighth switch Q8 to be turned on complementarily to the fifth switch Q5 and the seventh switch Q7, respectively, while having a duty ratio of 1−D_{L}. In addition, the control unit 300 may control the ninth to twelfth switches Q9 to Q12 included in the third bridge 130 to have the fixed duty ratio of 50%. The first to fourth switches Q1 to Q4 may have the fixed duty ratio of 50% regardless of the control by the control unit 300, as in the case described in an embodiment.

However, another embodiment differs from an embodiment described above because, in an embodiment described above, in order to apply V_{T2} as shown in FIG. 4, the fifth to eighth switches Q5 to Q8 have the fixed duty ratio of 50%, and the fifth and sixth switches Q5 and Q6 and the seventh and eighth switches Q7 and Q8 have the phase difference of Φ_{boost} or Φ_{buck}, respectively, thereby controlling each switch depending on whether the operation mode is the boost mode or the buck mode, whereas in another embodiment, the control unit 300 controls the fifth switch Q5 and the seventh switch Q7 to be turned on to have the duty ratio corresponding to the value of D_{L} and simultaneously controls the fifth switch Q5 to have a phase difference of Φ_{boost2} or φ_{buck2} from the first switch Q1 depending on whether the operation mode is the boost mode or the buck mode.

As a result, by adjusting the duty ratio and the phase difference between the fifth switch Q5 and the seventh switch Q7, the bidirectional isolated converter according to another embodiment may achieve the same effect as adjusting the voltage V_{T2} in an embodiment.

Among the first switch Q1 to the fourth switch Q4 included in the first bridge 110, the first switch Q1 and the fourth switch Q4 may be turned on together regardless of the operation mode, as in an embodiment. The second switch Q2 and the third switch Q3 may be operated complementarily to the first switch Q1 and the fourth switch Q4, respectively.

As shown in FIG. 11, when the bidirectional isolated converter according to another embodiment is operated in the boost mode, the control unit 300 may control the fifth switch Q5, among the fifth switch Q5 to the eighth switch Q8 included in the second bridge 120, to be turned on while having a predetermined phase difference from the first switch Q1 or the fourth switch Q4, and the seventh switch Q7 to be turned on while having a phase difference of 180° from the fifth switch Q5. Here, the predetermined phase difference between the fifth switch Q5 and the first switch Q1 or the fourth switch Q4 is referred to as φ_{boost2}.

In addition, the control unit 300 may control the eleventh switch Q11 to turn on while having a predetermined phase difference from the second switch Q2. Here, the predetermined phase difference between the eleventh switch Q11 and the second switch Q2 is referred to as Φₚₛ₂. The eleventh switch Q11 and the twelfth switch Q12 may be operated complementarily while having the duty ratio of 50%.

Simultaneously, the control unit 300 may control the tenth switch Q10 to be turned on while having a predetermined phase difference from the twelfth switch Q12. Here, the predetermined phase difference between the tenth switch Q10 and the twelfth switch Q12 is referred to as Φ_{h_boost}. Similarly, the ninth switch Q9 may be controlled by the control unit 300 to be turned on complementarily to the tenth switch Q10 while having the duty ratio of 50%.

In addition, the control unit 300 may control the fifth switch Q5 and the seventh switch Q7 to be turned on while having the predetermined duty ratio. Here, the predetermined duty ratio is referred to as D_{L}. Therefore, the fifth switch Q5 may be controlled to be turned on while having the duty ratio of D_{L}, the sixth switch Q6 may be controlled to be turned on complementarily to the fifth switch Q5 while having the duty ratio of 1−D_{L}. The seventh switch Q7 may also be controlled to be turned on while having the duty ratio of D_{L}, and the eighth switch Q8 may be controlled to be turned on complementarily to the seventh switch Q7 while having the duty ratio of 1−D_{L}.

As shown in FIG. 12, when the bidirectional isolated converter according to another embodiment is operated in the buck mode, the control unit 300 may control the fifth switch Q5, among the fifth switch Q5 to the eighth switch Q8 included in the second bridge 120, to be turned on while having a predetermined phase difference from the first switch Q1 or the fourth switch Q4, and the seventh switch Q7 to be turned on while having a phase difference of 180° from the fifth switch Q5. Here, the predetermined phase difference between the fifth switch Q5 and the first switch Q1 or the fourth switch Q4 is referred to as Φ_{buck2}.

In addition, the control unit 300 may control the eleventh switch Q11 to be turned on while having a predetermined phase difference from the second switch Q2. Here, the predetermined phase difference between the eleventh switch Q11 and the second switch Q2 is referred to as Φₚₛ₂. The eleventh switch Q11 and the twelfth switch Q12 may be operated complementarily while having the duty ratio of 50%.

Simultaneously, the control unit 300 may control the tenth switch Q10 to be turned on while having a predetermined phase difference from the twelfth switch Q12. Here, the predetermined phase difference between the tenth switch Q10 and the twelfth switch Q12 is referred to as Φ_{h_buck}. Similarly, the ninth switch Q9 may be controlled to be turned on complementarily to the tenth switch Q10 while having the duty ratio of 50%.

In addition, the control unit 300 may control the fifth switch Q5 and the seventh switch Q7 to be turned on while having a predetermined duty ratio. Here, the predetermined duty ratio is referred to as D_{L}. Therefore, the fifth switch Q5 may be turned on while having the duty ratio of D_{L}, and the sixth switch Q6 may be controlled to be turned on complementarily to the fifth switch Q5 while having the duty ratio of 1−D_{L}. The seventh switch Q7 may also be turned on while having the duty ratio of D_{L}, and the eighth switch Q8 may be controlled to be turned on complementarily to the seventh switch Q7 while having the duty ratio of 1−D_{L}.

Next, control variables of the bidirectional isolated converter according to another embodiment of the present invention are described.

Φ_{boost2} and Φ_{boost2} may be values set to enable zero voltage switching turn-on of the switch and to reduce a turn-off current. Specifically, the values of Φ_{boost2} and Φ_{boost2} may be determined based on values predetermined in a look-up table maintained by the control unit 300.

In the boost mode, a voltage waveform of V_{ab} may be adjusted by changing the value of Φ_{boost2}, which enables the zero voltage switching turn-on and reduces the turn-off current. For Φ_{buck2}, bucking needs to occur in the buck mode, and V_{ab} thus needs to be reduced, which causes the phase difference of 180°. The generator 310, which is included in the control unit 300 and described below, may read the values of Φ_{boost2} and Φ_{buck2} from the look-up table maintained by the control unit 300, and then generate values for controlling the fifth to eighth switches Q5 to Q8 included in the second bridge 120.

Φₚₛ₂, which is the predetermined phase difference between the eleventh switch Q11 and the second switch Q2, may serve to adjust the output voltage of the third bridge 130 in the same manner as in an embodiment. Specifically, in the boost mode according to another embodiment, when the control unit 300 increases Φₚₛ₂ to control the third bridge 130, the magnitude of the current i_{L}_{ᵣ} flowing through the resonant inductor Lᵣ during the period corresponding to the phase difference Φₚₛ₂ between the second switch Q2 and the eleventh switch Q11 may be increased, thereby increasing the amount of power transmitted to the third bridge 130. Conversely, when the control unit 300 decreases Φₚₛ₂ to control the third bridge 130, the magnitude of the current flowing through the resonant inductor Lᵣ during the period corresponding to the phase difference Φₚₛ₂ between the second switch Q2 and the eleventh switch Q11 may be reduced, thereby reducing the amount of power transmitted to the third bridge 130. Here, the reduction indicates a case where, when the bidirectional isolated converter according to another embodiment is operated in the boost mode, the boosting degree is increased or decreased depending on Φₚₛ₂, and does not indicate that the converter is operated in the boost mode or in the buck mode depending on Φₚₛ₂. To this end, the bidirectional isolated converter according to another embodiment of the present invention may further include the voltage sensor for sensing the battery voltage.

Next, the buck mode according to another embodiment is specifically described. In the buck mode, V_{T2} output from the second bridge 120 and the second transformer 220 may have the opposite polarity to V_{T1}. Accordingly, when the control unit 300 increases Φₚₛ₂, the amount of power transmitted to the third bridge 130 may be reduced, and when Φₚₛ₂ is decreased, the amount of power transmitted to the third bridge 130 may be increased. Here, the increase or the reduction indicates a case where the bucking degree is increased or decreased depending on Φₚₛ₂ when the bidirectional isolated converter according to another embodiment is operated in the buck mode, and does not indicate that the converter is operated in the boost mode or in the Φ_{buck} mode depending on Φₚₛ₂.

The control unit 300 may receive the current I_{bat} flowing toward the load (e.g., the battery 10) of the bidirectional isolated converter according to another embodiment of the present invention and the predetermined reference current I_{bat_ref}, and calculate Φₚₛ₂ in the boost mode or the buck mode. To this end, the bidirectional isolated converter according to another embodiment of the present invention may further include the current sensor for sensing the current flowing toward the load.

D_{L}, which is the predetermined duty ratio of the fifth switch Q5 and the seventh switch Q7, may serve to operate the second bridge 120 as the interleaved buck converter. Specifically, D_{L} may have the same relationship as in the following equation with respect to a voltage ratio between an input terminal voltage and a voltage of the low-voltage output terminal, as in a typical buck converter.

$${D}_{L} = {V}_{12 V} / {V}_{i n}$$

That is, the voltage of the low-voltage output terminal may be adjusted by adjusting D_{L}.

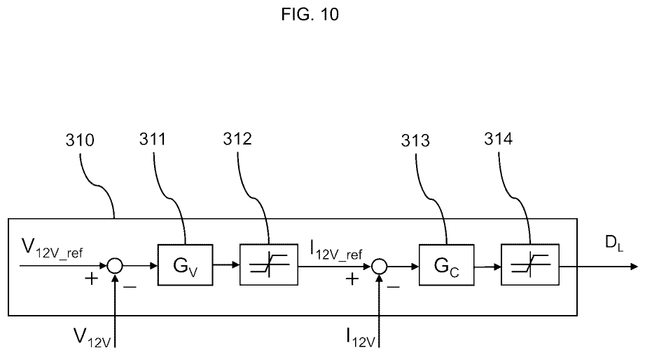

FIG. 10 is a schematic diagram of a generator included in the bidirectional isolated converter according to another embodiment of the present invention.

The control unit 300 included in the bidirectional isolated converter according to another embodiment of the present invention may further include the generator 310. The generator 310 may generate a duty ratio D_{L} for performing a constant current-constant voltage control to maintain a constant voltage and a constant current output from the low-voltage output terminal. To this end, the generator 310 may include a voltage controller 311, a first limiter 312, a current controller 313, and a second limiter 314. Here, the first limiter 312 and the second limiter 314 may basically perform a function of preventing saturation, surge, or the like due to error values generated in the voltage controller 311 and the current controller 313.

The voltage controller 311 and the first limiter 312 may calculate a reference current value I_{12V_ref} from the maximum current by using a difference value between V_{12V}, which is the voltage of the low-voltage output terminal, and V_{12V_ref}, which is a reference voltage value of the low-voltage output terminal.

Here, the voltage controller 311 may apply proportional integral (PI) control to the difference value between V_{12V}, which is the voltage of the low-voltage output terminal, and V_{12V_ref}, which is the reference current value of the low-voltage output terminal.

The first limiter 312 may limit a value output from the voltage controller 311 to be equal to or less than a value of the maximum current that may flow through the low-voltage output terminal.

The voltage controller 311 and the first limiter 312 may calculate D_{L} by using the difference value between I_{12V}, which is a current flowing through the low-voltage output terminal, and I_{12V_ref}, which is the reference current value of the low-voltage output terminal.

The current controller 313 may apply the PI control to the difference value between I_{12V}, which is the current flowing through the low-voltage output terminal and I_{12V_ref}, which is the reference current value of the low-voltage output terminal.

The second limiter 314 may receive a value output from the current controller 313 and limit the maximum and minimum values of D_{L}.

As a result, the control unit 300 may control the fifth to eighth switches Q5 to Q8 included in the second bridge 120 by using the duty ratio of D_{L} generated by the generator 310.

To this end, the bidirectional isolated converter according to another embodiment of the present invention may further include the voltage sensor for sensing V_{12V}, which is the voltage of the low-voltage output terminal, and the current sensor for sensing I_{12V}, which is the current flowing through the low-voltage output terminal.

Φ_{h_boost} or Φ_{h_buck}, which is the phase difference between the tenth switch Q10 and the twelfth switch Q12, may serve to adjust a voltage Vcd. The reason is that an optimal operation, such as reducing a loss occurring in a dual active bridge (DAB) converter, is possible when root mean square (RMS) values of the voltages of V_{ab} and Vcd are adjusted to be the same as each other due to a circuit characteristic of the dual active bridge (DAB) converter. The values of Φ_{h_boost} and Φ_{h_buck} may vary depending on the voltage of the battery 10. That is, Φ_{h_boost} or Φ_{h_buck}, which is the phase difference between the tenth switch Q10 and the twelfth switch Q12 may be calculated based on the battery voltage. In the boost mode, the control unit 300 may adjust the voltage Vcd by changing the value of Φ_{h_boost} by considering that the voltage of the battery 10 is high. In the buck mode, the control unit 300 may adjust the voltage Vcd by changing the value of Φ_{h_buck} by considering that the voltage of the battery 10 is low. However, the voltage of the battery 10 may be low in the buck mode, and the control unit 300 may thus set Φ_{h_buck}, which is the phase difference between the tenth switch Q10 and the twelfth switch Q12, to 180°, thereby applying all the voltage of the battery 10 to Vcd. That is, Φ_{h_boost} and Φ_{h_buck} are variable values that are not limited to the above-mentioned values when the power or voltage of the battery is changed.

Although the embodiments of the present invention are shown and described as above, the embodiments of the present invention are not intended to limit the spirit of the present invention, but rather to describe the same. Accordingly, the spirit of the present invention includes not only each disclosed embodiment but also combinations of the disclosed embodiments. Furthermore, the scope of the present invention is not limited to these embodiments. In addition, the present invention may be variously changed and modified by those skilled in the art to which the present invention pertains without departing from the spirit and scope of the appended claims, and all such appropriate changes and modifications should be considered equivalent and fall within the scope of the present invention.

1. A bidirectional isolated converter comprising:
a first bridge receiving a direct current through an input terminal and including at least one switch leg including two switches operated complementarily;
a second bridge receiving the direct current through an input terminal, including at least one switch leg including two switches operated complementarily, and connected in parallel with the first bridge;
a first transformer including a first primary side and a first secondary side connected to the first bridge;
a second transformer including a second primary side and a second secondary side connected to the second bridge, the second secondary side being connected in series with the first secondary side;
a third bridge connected to the first secondary side and the second secondary side, including at least one switch leg including two switches operated complementarily, and having a load connected to an output terminal; and
a control unit controlling the switches included in the second bridge and the third bridge to control the switches to be in either a boost mode or a buck mode,
controlling the first secondary side and the second secondary side to have the same polarity during at least some periods in the boost mode, and
controlling the first secondary side and the second secondary side to have opposite polarities during at least some periods in the buck mode.

2. The converter of claim 1, wherein the control unit controls the switches included in the switch leg included in each of the first to third bridges to have the same duty ratio, and
adjusts an output voltage of the third bridge by changing a phase difference between the switches included in the third bridge based on the switches included in the first bridge.

3. The converter of claim 1, wherein the switches included in the first bridge have a fixed duty ratio.

4. The converter of claim 3, wherein the switches included in the first bridge have the fixed duty ratio of 50%.

5. The converter of claim 1, wherein the first bridge includes a first switch leg and a second switch leg, which are connected in parallel with each other,
the second bridge includes a third switch leg and a fourth switch leg, which are connected in parallel with each other,
the third bridge includes a fifth switch leg and a sixth switch leg, which are connected in parallel with each other, and
an n-th switch leg includes a (2n−1)-th switch and a (2n)-th switch, which are connected in series with each other and operated complementarily (where, n is a natural number greater than or equal to 1 and less than or equal to 6).

6. The converter of claim 5, wherein the load is a battery,
wherein the first switch and the fourth switch are turned on simultaneously, and
in the boost mode,
the control unit controls the eighth switch to be turned on simultaneously with the first switch,
controls the sixth switch to be turned on while having a predetermined phase difference from the eighth switch,
controls the ninth switch and the twelfth switch to be turned on simultaneously while having a predetermined phase difference from the first switch, and
calculates the phase difference between the sixth switch and the eighth switch and the phase difference between the ninth switch and the first switch based on a battery voltage.

7. The converter of claim 5, wherein the load is a battery,
wherein the first switch and the fourth switch are turned on simultaneously, and
in the buck mode,
the control unit controls the sixth switch to be turned on simultaneously with the first switch,
controls the sixth switch to be turned on while having a predetermined phase difference from the eighth switch,
controls the ninth switch and the twelfth switch to be turned on simultaneously while having a predetermined phase difference from the first switch, and
calculates the phase difference between the sixth switch and the eighth switch and the phase difference between the ninth switch and the first switch based on a battery voltage.

8. (canceled)

9. The converter of claim 5, comprising:
a first inductor having one end connected between the fifth switch and the sixth switch and the other end connected to a low-voltage output terminal; and
a second inductor having one end connected between the seventh switch and the eighth switch and the other end connected to the other end of the first inductor.

10. The converter of claim 9, wherein the first switch and the fourth switch are turned on simultaneously, and
in the boost mode,
the control unit controls the fifth switch to be turned on while having a predetermined phase difference from the first switch, and the seventh switch to be turned on while having a phase difference of 180° from the fifth switch,
controls the eleventh switch to be turned on while having a predetermined phase difference from the second switch, and the tenth switch to be turned on while having a predetermined phase difference from the twelfth switch, and
controls the fifth switch and the seventh switch to be turned on while having a predetermined duty ratio.

11. The converter of claim 9, wherein the first switch and the fourth switch are turned on simultaneously, and
in the buck mode,
the control unit controls the fifth switch to be turned on while having a predetermined phase difference from the first switch, and the seventh switch to be turned on while having a phase difference of 180° from the fifth switch,
controls the eleventh switch to be turned on while having a predetermined phase difference from the second switch, and the tenth switch to be turned on while having a predetermined phase difference from the twelfth switch, and
controls the fifth switch and the seventh switch to be turned on while having a predetermined duty ratio.

12. The converter of claim 10, wherein the control unit controls the predetermined duty ratio of the fifth switch and the seventh switch by using a difference between a current flowing through a low-voltage input terminal and a reference current and a difference between a voltage of the low-voltage input terminal and a reference voltage.

13. The converter of claim 10, wherein the load is a battery, and
the control unit calculates the phase difference between the fifth switch and the first switch based on a battery voltage.

14. The converter of claim 1, comprising:
a resonant inductor disposed between one of the first transformer and the second transformer and the third bridge; and
a resonant capacitor disposed between one of the first transformer and the second transformer and the third bridge.

15. The converter of claim 1, further comprising a direct current (DC) link capacitor connected in parallel with the first bridge and the second bridge.

16. The converter of claim 1, further comprising an output capacitor connected in parallel with the output terminal of the third bridge.

17. The converter of claim 2, wherein the control unit calculates the phase difference between the switches included in the first bridge and the switches included in the third bridge based on a difference between a current flowing through the output terminal of the third bridge and a predetermined reference current.

18. The converter of claim 1, wherein a turns ratio of the first transformer is 1:N1, and a turns ratio of the second transformer is 1:N2,
N1 being greater than N2.

19. The converter of claim 18, wherein N1 is 2.5 times or more than N2.

20. The converter of claim 11, wherein the control unit controls the predetermined duty ratio of the fifth switch and the seventh switch by using a difference between a current following through a low-voltage input terminal and a reference current and a difference between a voltage of the low-voltage input terminal and a reference voltage.

21. The converter of claim 11, wherein the load is a battery, and the control unit calculates the phase difference between the fifth switch and the first switch based on a battery voltage.
